(19) United States
(12) Patent Application Publication
(10) Pub. No.: US 2024/0074497 A1
(43) Pub. Date: Mar. 7, 2024

(54) ATOMIZATION DEVICE

(71) Applicant: SHENZHEN RELX TECHNOLOGY CO., LTD., ShenZhen (CN)

(72) Inventors: HUI WANG, Shenzhen (CN); XIANG-HUANG FENG, Shenzhen (CN); SHENG-YANG XU, Shenzhen (CN)

(21) Appl. No.: 18/242,830

(22) Filed: Sep. 6, 2023

(30) Foreign Application Priority Data
Sep. 6, 2022 (CN) 202222368192.4

(51) Int. Cl. A24F 40/42; A24F 40/46; A24F 40/51; A24F 40/95

(52) U.S. Cl. CPC A24F 40/42; A24F 40/46; A24F 40/51; A24F 40/95

(57) ABSTRACT

The present disclosure provides an atomization device, which includes a cartridge module, a battery module, and a connection module. The cartridge module includes a heating member. The heating member has a first pin and a second pin. The battery module has a first electrode and a second electrode. The connection module is detachably connected to the cartridge module and the battery module. The connection module has a first conductive member and a second conductive member. A first end of the first conductive member is in contact with the first pin. A second end of the first conductive member is electrically connected to the first electrode. A first end of the second conductive member is in contact with the second pin. A second end of the second conductive member is in contact with the second electrode. False soldering or poor soldering is reduced, thereby reducing the failure of the atomization device.

### FIELD

The subject matter relates to electronic cigarettes, and more particularly, to an atomization device.

### BACKGROUND

An atomization device can atomize an e-liquid to generate smoke. The atomization device includes a heating member and a battery for energizing the heating member, so that the heating member can generate heat that atomizes the e-liquid. In related arts, the battery may be fixed to the heating member by soldering, thereby allowing the battery to be electrically connected to the heating member. However, false soldering or poor soldering may happen between the battery and the heating member, which prevents the battery from normally energizing the heating member.

Therefore, there is room for improvement in the art.

### SUMMARY

The present disclosure provides an atomization device, which includes a cartridge module, a battery module, and a connection module. The cartridge module includes a heating member. The heating member includes a first pin and a second pin. The battery module includes a first electrode and a second electrode. The connection module is detachably connected to the cartridge module and the battery module. The connection module includes a first conductive member and a second conductive member. The first conductive member includes a first end and a second end. The second conductive member includes a first end and a second end. The first end of the first conductive member is in contact with the first pin, and the second end of the first conductive member is electrically connected to the first electrode. The first end of the second conductive member is in contact with the second pin, and the second end of the second conductive member is in contact with the second electrode.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

Implementations of the present technology will now be described, by way of example only, with reference to the attached figures.

FIG. 1 is a cross-sectional view of an atomization device according to an embodiment of the present disclosure.

FIG. 2 is an exploded view of the atomization device in FIG. 1.

FIG. 3 is another exploded view of the atomization device in FIG. 1.

FIG. 4 is a partial view of a module of the atomization device in FIG. 1.

FIG. 5 is a bottom diagrammatic view of a connection module of the atomization device in FIG. 1.

FIG. 6 is an enlarged view of the connection module of the atomization device in FIG. 1.

FIG. 7 is a bottom diagrammatic view of a cartridge module of the atomization device in FIG. 1.

FIG. 8 is a diagrammatic view of a battery of the atomization device in FIG. 1.

FIG. 9 is a diagrammatic view showing the battery connected to a bracket of the atomization device in FIG. 1.

FIG. 10 is a diagrammatic view of a battery of an atomization device according to another embodiment of the present disclosure.

FIG. 11 is a diagrammatic view of a battery of an atomization device according to yet another embodiment of the present disclosure.

FIG. 12 is a diagrammatic view of a battery of an atomization device according to yet another embodiment of the present disclosure.

FIG. 13 is an exploded view of the atomization device in FIG. 1.

FIG. 14 is a cross-section view of an atomization device according to another embodiment of the present disclosure.

FIG. 15 is a diagrammatic view of a connection module of the atomization device in FIG. 14.

FIG. 16 is an exploded view of the connection module in FIG. 15.

### DETAILED DESCRIPTION

The embodiments of the present disclosure will be described in detail below. Throughout the specification, the same or similar components and components having the same or similar functions are denoted by similar reference numerals. The embodiments described herein with respect to the drawings are illustrative, and are used for providing a basic understanding of the present disclosure. The embodiments of the present disclosure should not be interpreted as limitations to the present disclosure.

In the description of the present disclosure, orientations or positional relationships indicated by terms “middle”, “length”, “thickness”, “on”, “under”, “horizontal”, “top”, “bottom”, “inside”, and “outside” are indicated relative to the orientations or positional relationships shown in the attached drawings. The above terms are only for the convenience of describing and simplifying the present disclosure, and are not intended to indicate or imply that the devices or components referred to must have specific orientations or must be constructed and operated in the specific orientations. Thus, the above terms are not intended to limit the implementation scope of the present disclosure. In addition, the terms “first” and “second” are only used for describing purpose, and not intended to indicate or imply the relative importance or to imply the quantity of the features referred to. Therefore, the feature limited by “first” or “second” can explicitly or implicitly include one or more of the said features. In the description of the present disclosure, “multiple” means two or more unless otherwise specified.

In the description of the present disclosure, unless otherwise specified, the terms “install”, “fix”, and “connect” should be broadly understood as, for example, fixedly connect, detachably connect, or integrally connect. The above terms may also be understood as mechanically connect, electrically connect, or communicatively connect. The above terms may also be understood as directly connect or indirectly connect through an intermediate medium. The above terms may also be understood as internally connect two components or interact between the two components. For one having ordinary skill in the art, the specific meanings of the above terms in the present disclosure can be understood based on specific circumstances.

In the present disclosure, unless otherwise specified, when a first feature is described as being on or under a second feature, the first feature and the second feature may be in direct contact with each other. The first feature and the second feature may also be in indirect contact with each other through an additional feature therebetween. Moreover, when the first feature is described as being on, above, or over the second feature, the first feature may be directly or diagonally above the second feature, or a horizontal height of the first feature may be large than that of the second feature. When the first feature is described as being under or below the second feature, the first feature may be directly or diagonally below the second feature, or the horizontal height of the first feature may be less than that of the second feature.

The following description provides various embodiment or examples to implement different structures of the present disclosure. Only specific components and configurations in the embodiment or examples are described below for simplicity. Of course, they are only examples and are not considered as limiting the scope of the present disclosure. In addition, reference numerals have been repeated among different embodiments or examples to indicate corresponding or analogous members for simplicity, and are not intended to indicate the relationship among the different embodiments or examples discussed herein. In addition, the present disclosure also provides examples of various specific processes and materials, but one having ordinary skill in the art will realize that other processes and materials may also be used.

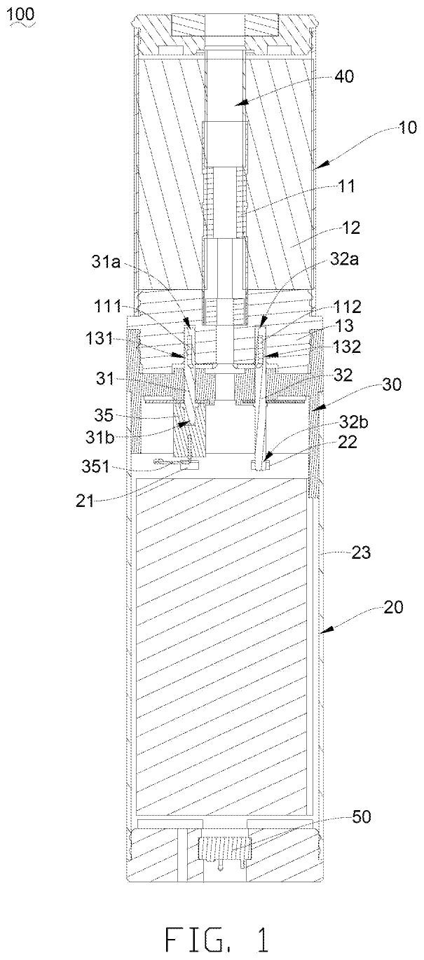

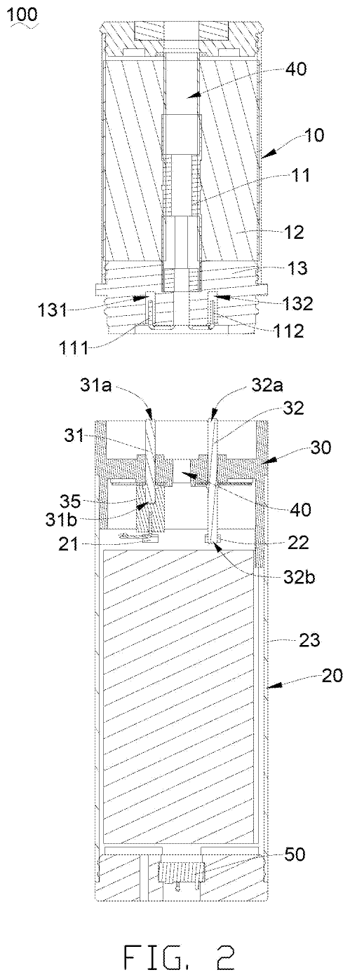

Referring to FIGS. 1 to 3, an atomization device 100 is provided according to an embodiment of the present disclosure, which includes a cartridge module 10, a battery module 20, and a connection module 30. The cartridge module 10 includes a heating member 11. The heating member 11 includes a first pin 111 and a second pin 112. The battery module 20 includes a first electrode 21 and a second electrode 22. The connection module 30 is detachably connected to the cartridge module and the battery module 20. The connection module 30 includes a first conductive member 31 and a second conductive member 32. A first end 31a of the first conductive member 31 is in contact with the first pin 111, and a second end 31b of the first conductive member 31 is electrically connected to the first electrode 21. A first end 32a of the second conductive member 32 is in contact with the second pin 112, and a second end 32b of the second conductive member 32 is in contact with the second electrode 22.

In the atomization device 100 of the present disclosure, the connection module 30 connect and assembles the cartridge module 10 to the battery module 20. The first pin 111 of the heating member 11 is electrically connected to the first electrode 21 of the battery module 20 through the first conductive member 31 of the connection module 30. The second pin 112 of the heating member 11 is electrically connected to the second electrode 22 of the battery module 20 through the second conductive member 32 of the connection module 30. The cartridge module 10 is not connected to the battery module 20 by soldering, which can reduce false soldering or poor soldering between the cartridge module 10 and the battery module 20, thereby reducing the failure of the atomization device 100.

In one embodiment, the cartridge module 10 may be a cylindrical structure having a cartridge placed therein. An upper portion of the cartridge module 10 may be provided with a sealing member (not labeled), and the sealing member may be made of silicone. The cartridge may be placed in a middle portion of the cartridge module 10. The heating member 11 may be installed at a lower portion of the cartridge module 10. The heating member 11 may be a heating wire that can be in contact with and heat the cartridge, thereby evaporating an e-liquid or other similar substances in the cartridge to form smoke. The first pin 111 and the second pin 112 of the heating member 11 may extend toward the outside of the cartridge module 10. The first pin 111 and the second pin 112 may be symmetrical with each other on the heating member 11. Each of the first pin 111 and the second pin 112 may be curved like a hook.

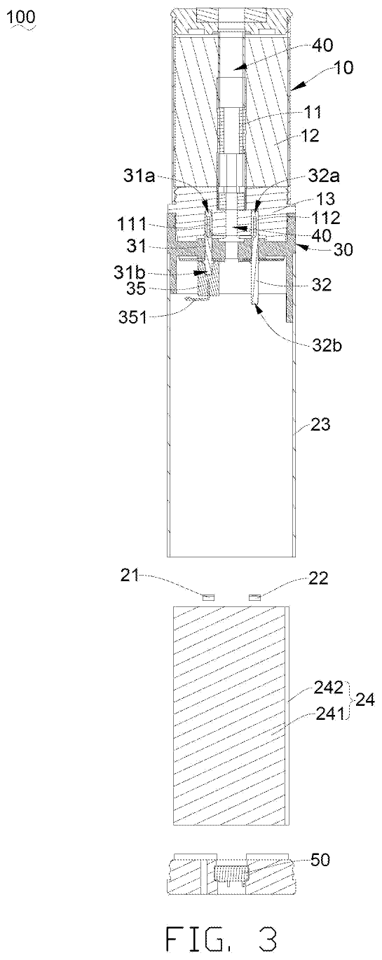

Referring to FIG. 3, the battery module 20 further includes a battery 24. Each of the first electrode 21 and the second electrode 22 may be an elastic piece. The first electrode 21 and the second electrode 22 may be located on a same end of the battery module 20. In one embodiment, the first electrode 21 may be connected to a positive electrode plate of the battery 24, and the second electrode 22 may be connected to a negative electrode plate of the battery 24. In another embodiment, the first electrode 21 may be connected to the negative electrode plate of the battery 24, and the second electrode 22 may be connected to the positive electrode plate of the battery 24.

The connection module 30 can detachably connect the cartridge module 10 to the battery module 20, for example, by insertion connection or snapping engagement. The first conductive member 31 of the connection module 30 may correspond to the first pin 111 of the cartridge module and the first electrode 21 of the battery module 20. The second conductive member 32 of the connection module 30 may correspond to the second pin 112 of the cartridge module 10 and the second electrode 22 of the battery module 20.

When the cartridge module 10 and the battery module 20 are connected through the connection module 30, the first pin 111 of the cartridge module 10 may come in contact with the first end 31a of the first conductive member 31, and the first electrode 21 of the battery module 20 may be electrically connected to the second end 31b of the first conductive member 31. The first end 31a and the second end 31b may be opposite ends of the first conductive member 31 along a length direction of the first conductive member 31. The second pin 112 of the cartridge module 10 may come in contact with the first end 32a of the second conductive member 32, and the second electrode 22 of the battery module 20 may come in contact with the second end 32b of the second conductive member 32. The first end 32a and the second end 32b may be opposite ends of the second conductive member 32 along a length direction of the second conductive member 32. The length direction of the first conductive member 31 or the second conductive member 32 may be the same as the length direction of the atomization device 100.

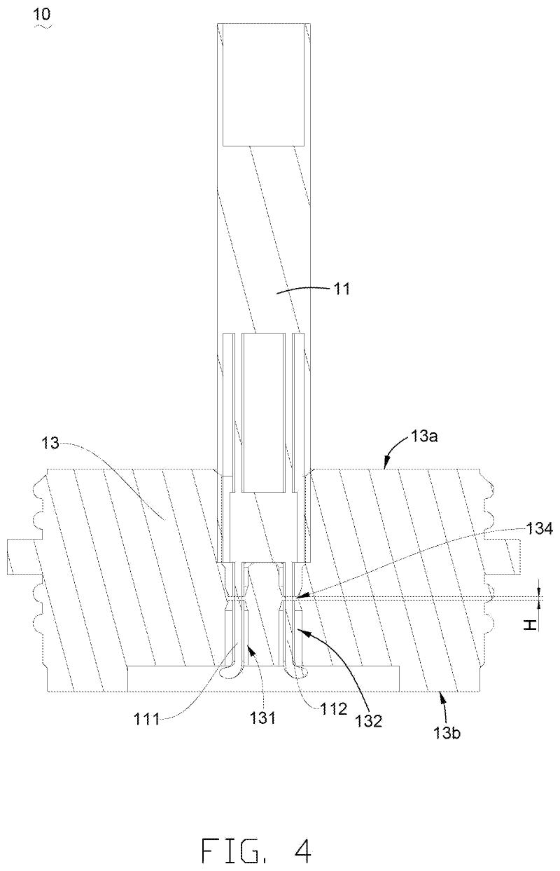

Referring to FIGS. 1 to 4, in one embodiment, the cartridge module 10 further includes a storage chamber 12 and another sealing member 13. The first pin 111 and the second pin 112 are fixed to the sealing member 13.

The storage chamber 12 can store the e-liquid or other similar substances. The sealing member 13 can seal the storage chamber 12, and also facilitate the connection of the first pin 111 and the second pin 112 to the sealing member 13.

The storage chamber 12 may be located in the middle portion of the cartridge module 10. The storage chamber 12 can have a cylindrical hollow structure. The sealing member 13 is located on an end of the storage chamber 12 facing the battery module 20. The sealing member 13 may be made of silicone. An outer periphery of the sealing member 13 may have zigzag-shaped structures. The sealing member 13 may be connected to the inner wall of a lower portion of the storage chamber 12 by interference fit, thereby sealing the storage chamber 12. A lower end of the heating member 11 may be fixed by the sealing member 13. A contact area between a first end surface 13a of the sealing member 13 and the heating member 11 may form a C-angle. The first pin 111 and the second pin 112 of the heating member 11 may extend from the first end surface 13a to the pin holes 134 of the sealing member 13, and then protrude from a second end surface 13b of the sealing member 13 opposite to the first end surface 13a. The portion of each of the first pin 111 and the second pin 112 protruding from the second end surface 13b is bent. Each pin hole 134 may be provided with a thin film, and a thickness H of the thin film may be between 0.05 mm to 0.3 mm.

Referring to FIGS. 1 to 4, in one embodiment, the second end surface 13b of the sealing member 13 is recessed to form a first slot 131 and a second slot 132. The first pin 111 is located in the first slot 131, and the second pin 112 is located in the second slot 132. The first end 31a of the first conductive member 31 is inserted into the first slot 131, and the first end 32a of the second conductive member 32 is inserted into the second slot 132.

The first slot 131 of the sealing member 13 can facilitate the connection between the first conductive member 31 and the first pin 111. The second slot 132 of the sealing member 13 can facilitate the connection between the second conductive member 32 and the second pin 112.

In one embodiment, the second end surface 13b of the sealing member 13 is recessed toward the inside of the sealing member 13 to form the first slot 131 and the second slot 132. A depth direction of each of the first slot 131 and the second slot 132 is the same as the length direction of the atomization device 100. The second slot 132 may be spaced apart from the first slot 131. The first slot 131 and the second slot 132 may be symmetrical with each other in the sealing member 13. After the first pin 111 is bent, the first pin 111 can be inserted into the first slot 131, and the first conductive member 31 can also be inserted into the first slot 131 and come into contact with the first pin 111. After the second pin 112 is bent, the second pin 112 can be inserted into the first slot 131, and the second conductive member 32 can also be inserted into the second slot 132 and come into contact with the second pin 112.

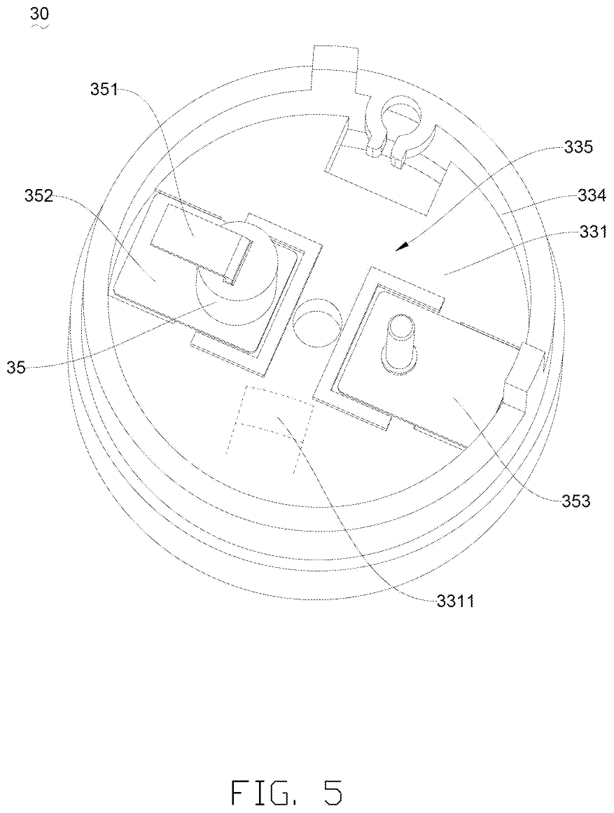

Referring to FIGS. 5 to 7, in one embodiment, the connection module 30 further includes a bracket 33. The bracket 33 is detachably sleeved on the sealing member 13. The first conductive member 31 and the second conductive member 32 are installed on the bracket 33.

The bracket 33 can fix the first conductive member 31 and the second conductive member 32 thereon, and also facilitate the connection of the sealing member 13 to the battery module 20.

In one embodiment, the bracket 33 may be annular with a stepped structure. The bracket 33 may be detachably connected to the sealing member 13. For example, the sealing member 13 may be connected to the bracket 33 by interference fit. The first conductive member 31 and the second conductive member 32 may be fixed to the bracket 33 by riveting.

Referring to FIGS. 5 to 7, in one embodiment, the bracket 33 includes a bracket body 331 and a first wall 332 connected to the bracket body 331. The bracket body 331 and the first wall 332 cooperatively define a first receiving space 333. The sealing member 13 is partially received in the first receiving space 333. The first conductive member 31 and the second conductive member 32 are inserted into the bracket body 331. In one embodiment, the first conductive member 31 and the second conductive member 32 may be inserted into the bracket body 331 along the thickness direction of the bracket body 331.

In one embodiment, the bracket body 331 may be a flat structure with a certain thickness. The bracket body 331 is formed in the middle portion of the bracket 33 and perpendicular to the axis of the bracket 33.

The bracket body 331 may divide the bracket 33 into two portions. One portion above the bracket body 331 is the first wall 332, which may be formed by extending from the outer periphery of the bracket body 331 along the length direction of the atomization device 100. The bracket body 331 and the first wall 332 cooperatively define the first receiving space 333. The sealing member 13 can be installed in the first receiving space 333 through interference fit. The first end 31a of the first conductive member 31 inserted into the bracket body 331 may be surrounded by the first wall 332. The first end 32a of the second conductive member 32 inserted into the bracket body 331 may also be surrounded by the first wall 332. When the sealing member 13 is received in the first receiving space 333, the first end 31a of the first conductive member 31 will extend into the first slot 131 and come into contact with the first pin 111, and the first end 32a of the second conductive member 32 will extend into the second slot 132 and come into contact with the second pin 112.

Referring to FIGS. 5 to 7, in one embodiment, the bracket body 331 is provided with a first position limiting structure, and the sealing member 13 is provided with a second position limiting structure. The first position limiting structure can cooperate with the second position limiting structure to limit the position of the connection module 30 relative to the cartridge module 10. For example, the first position limiting structure may be a hook, a protrusion, or a groove. The second position limiting structure may be a hook, a groove, or a protrusion, respectively, for matching the first position limiting structure.

The first and the second position limiting structures can provide a fool-proofing function when the connection module 30 is connected to the cartridge module 10, thereby reducing the position errors of the connection module 30 and the cartridge module 10 when the connection module 30 is connected to the cartridge module 10.

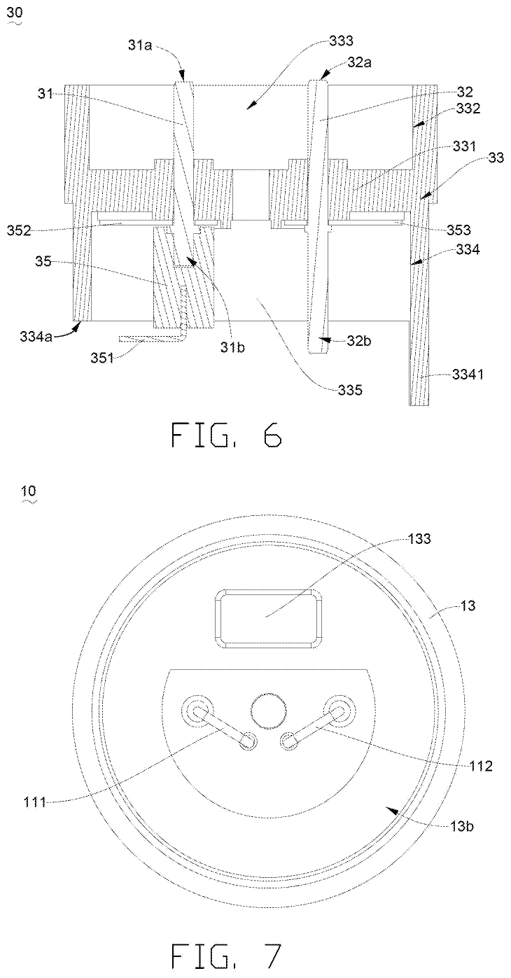

Referring to FIGS. 5 and 7, in one embodiment, the first position limiting structure includes a first limiting block 3311 received in the first receiving space 333. The second position limiting structure includes a first limiting groove 133 defined on the second end surface 13b of the sealing member 13. The first limiting block 3311 is fixed in the first limiting groove 133.

The setting of the first limiting block 3311 and the first limiting groove 133 can facilitate the assembly and connection between the connecting module 30 and the cartridge module 10, and can provide a fool-proofing function during the assembly process.

In one embodiment, the first limiting block 3311 may be a block protruding from the bracket body 331 towards the first receiving space 333. The first limiting groove 133 may be a groove recessed from the second end surface 13b of the sealing member 13 toward the inside of the sealing member 13. The first limiting groove 133 matches the first limiting block 3311. When the sealing member 13 is partially received in the first receiving space 333, the first limiting block 3311 is fixed in the first limiting groove 133, thereby ensuring a stable connection between the connection module and the cartridge module 10.

Referring to FIGS. 5 to 7, in one embodiment, the bracket 33 further includes a second wall 334. The bracket body 331 is located between the second wall 334 and the first wall 332. The second wall 334 and the bracket body 331 cooperatively define a second receiving space 335. After the first conductive member 31 is inserted into the bracket body 331, the second end 31b of the first conductive member 31 is surrounded by the second wall 334. After the second conductive member 32 is inserted into the bracket body 331, the second end 32b of the second conductive member 32 is surrounded by the second wall 334.

The battery module 20 further includes a housing 23. The battery 24 is received in the housing 23. The second wall 334 is embedded in the housing 23.

The second receiving space 335 defined by the bracket body 331 and the second wall 334 can partially receive the first conductive member 31 and the second conductive member 32. The housing 23 can protect the battery 24 and allows the second wall 334 to be embedded in the housing 23.

In one embodiment, the second wall 334 may be located below the bracket body 331. When the first conductive member 31 is inserted into the bracket body 331, the second end 31b of the first conductive member 31 may be received in the second receiving space 335. When the second conductive member 32 is inserted into the bracket body 331, the second end 32b of the second conductive member 32 may be located outside the second receiving space 335.

The housing 23 may be made of plastic. The battery 24 is connected to the first pin 111 and the second pin 112 through the first conductive member 31 and the second conductive member 32, respectively, thereby energizing the heating member 11. A length of the housing 23 may be greater than a length of the battery 24. The second wall 334 of the bracket 33 may be embedded in the housing 23 and located above the battery 24.

Referring to FIGS. 8 to 12, in one embodiment, the battery 24 includes a power end 243 facing the cartridge module 10. The first electrode 21 and the second electrode 22 are both located on the power end 243. The power end 243 may also face the second receiving space 335 defined by the bracket body 331 and the second wall 334.

The first electrode 21 and the second electrode 22, which are located on the same end of the battery 24, can facilitate the connection of the first conductive member 31 and the second conductive member 32 to the battery module 20.

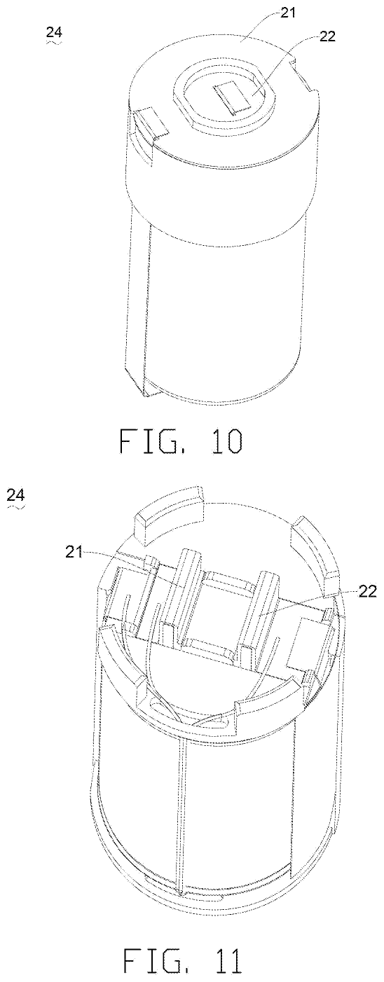

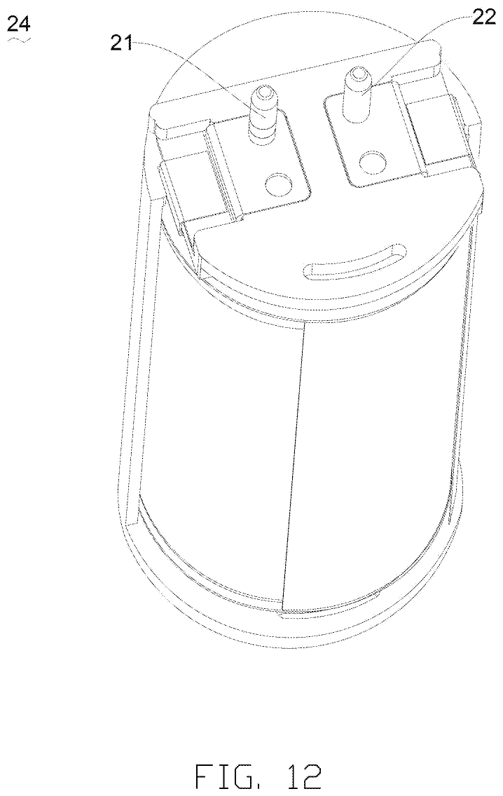

The first electrode 21 and the second electrode 22 of the battery 24 may have different structures. For example, in another embodiment shown in FIG. 10, the second electrode 22 is located in the inner side, and the first electrode 21 is annular surrounding an outer edge of the second electrode 22. In yet another embodiment shown in FIG. 11, the first electrode 21 and the second electrode 22 are both conductive plates. In yet another embodiment shown in FIG. 12, the first electrode 21 and the second electrode 22 are both conductive posts.

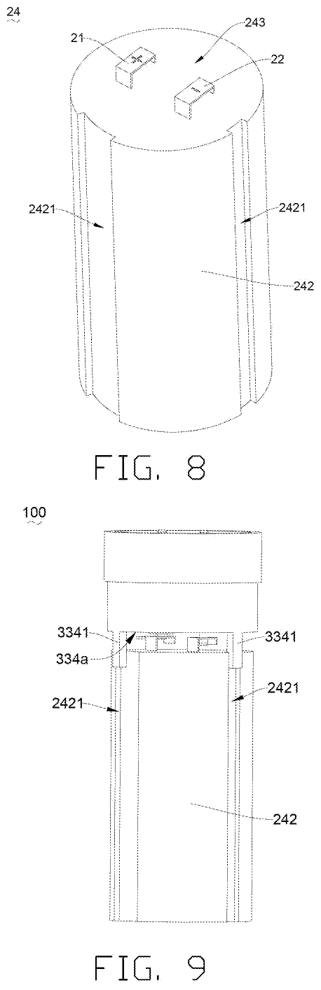

Referring to FIGS. 8 and 9, in one embodiment, the battery 24 further includes a battery cell 241 and a shell 242. The battery cell 241 is received in the shell 242. The shell 242 is provided with a third position limiting structure. The second wall 334 is provided with a fourth position limiting structure. The third position limiting structure cooperative with the fourth position limiting structure to limit the position of the connection module 30 relative to the battery module 20.

The third position limiting structure and the fourth position limiting structure can provide a fool-proofing function when the connection module 30 is connected to the battery module 20, thereby reducing position errors of the connection module 30 and the battery module 20 when the connection module 30 is connected to the battery module 20.

In one embodiment, the shell 242 may be made of plastic, which surrounds the battery cell 241 to form the battery 24. The third position limiting structure is provided on the outer periphery of the shell 242. The fourth position limiting structure may be provided on the first end surface 334a of the second wall 334 away from the bracket body 331. The fourth position limiting structure matches the third position limiting structure. The cooperation between the third position limiting structure and the fourth position limiting structure can ensure a stable connection between the connection module and the battery module 20.

Referring to FIGS. 8 and 9, in one embodiment, the third position limiting structure includes a second limiting groove 2421 defined on the shell 242. The fourth position limiting structure includes a second limiting block 3341 located on the first end surface 334a of the second wall 334 away from the bracket body 331. The second limiting block 3341 can be fixed in the second limiting groove 2421.

The cooperation of the second limiting groove 2421 and the second limiting block 3341 can facilitate the connection of the connection module 30 and the battery module 20 at the desired assembly position, and can provide a fool-proofing function during the assembly process of the connection module 30 and the battery module 20.

In one embodiment, the outer periphery of the shell 242 is recessed to form the second limiting groove 2421. The number of the second limiting groove(s) 2421 may be one or multiple. The multiple second limiting grooves 2421 may be spaced from each other along the peripheral direction of the shell 242. The second limiting block(s) 3341 may also be one or multiple. The second limiting block 3341 may be a block protruding from the first end surface 334a of the second wall 334 away from the bracket body 331. The second limiting block 3341 matches the second limiting groove 2421 in shape. When the connection module 30 is connected to the battery module 20, the second limiting block 3341 is inserted into the second limiting groove 2421 to limit the position of the connection module 30 relative to the battery module 20.

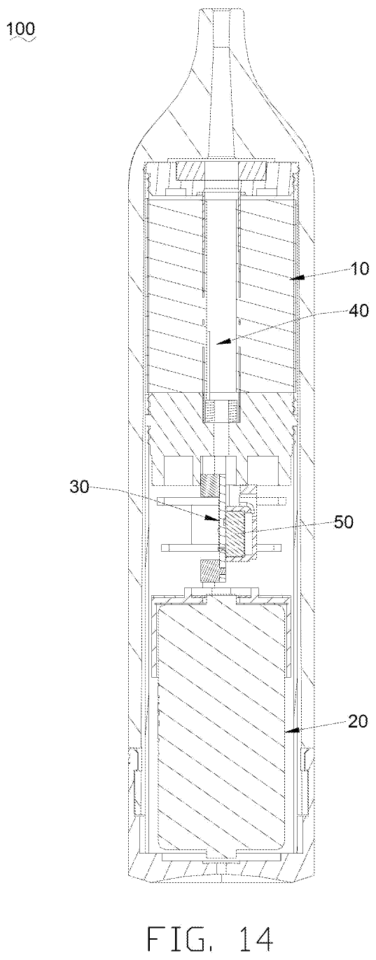

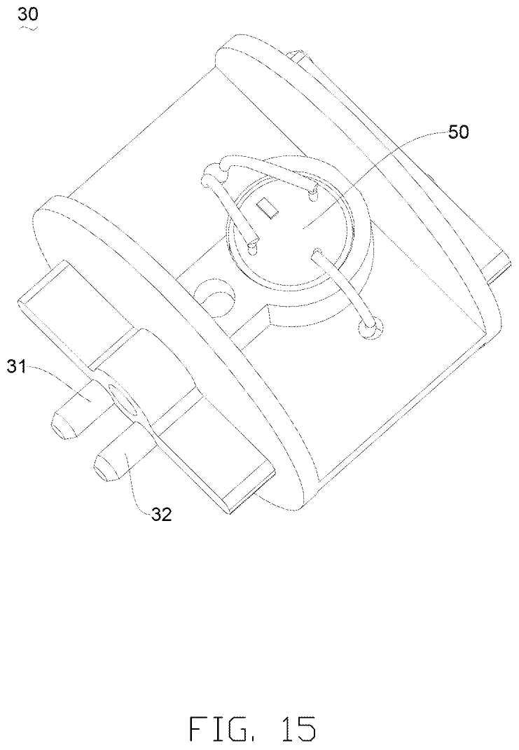

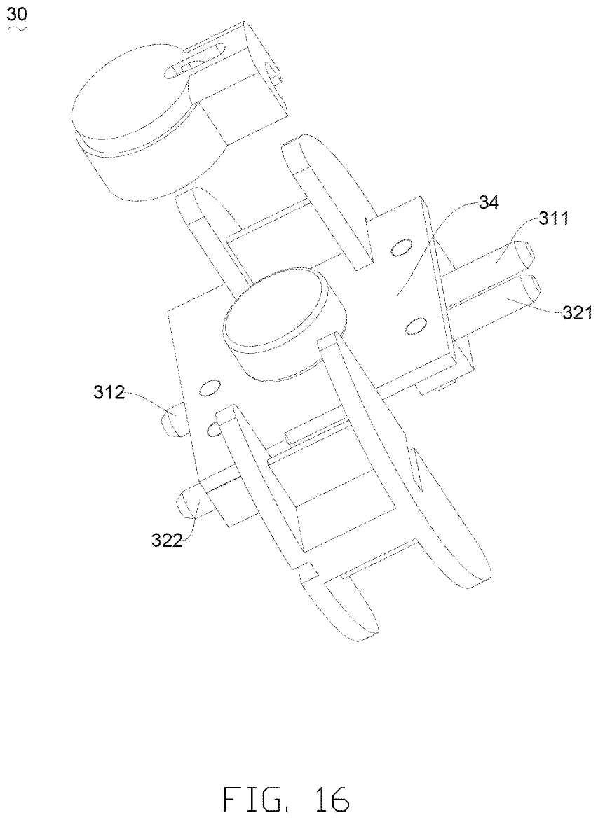

Referring to FIGS. 14 to 16, in another embodiment, the connection module 30 further includes a circuit board 34. The first conductive member 31 and the second conductive member 32 are installed on the circuit board 34. The first conductive member 31 may include a first conductive portion 311 and a second conductive portion 312 separated from the first conductive portion 311. The first conductive portion 311 includes the first end 31a of the first conductive member 31, and the second conductive portion 312 includes the second end 31b of the first conductive member 31. The first conductive portion 311 is electrically connected to the second conductive portion 312 through the circuit board 34.

Furthermore, the second conductive member 32 includes a third conductive portion 321 and a fourth conductive portion 322 separated from the third conductive portion 321. The third conductive portion 321 includes the first end 32a of the second conductive member 32, and the fourth conductive portion 322 includes the second end 32b of the second conductive member 32. The third conductive portion 321 is electrically connected to the fourth conductive portion 322 through the circuit board 34.

The connection module 30 uses the circuit board 34 to connect the two ends of the first conductive member 31 and to connect the two ends of the second conductive member 32. As such, separate connectors are formed at two sides of the circuit board 34, thereby allowing the connection module 30 to be detachably connected to the cartridge module 10 and the battery module 20. Thus, the automatic assembly and disassembly of the atomization device 100 are realized.

In one embodiment, each of the first conductive member 31 and the second conductive member 32 may extend along a length direction of the circuit board 34. The first conductive portion 311 may be one end of the first conductive member 31 located outside the circuit board 34, and the second conductive portion 312 may be another end of the first conductive member 31 located outside the circuit board 34. The first conductive portion 311 and the second conductive portion 312 may be separated from and electrically connected to each other through the circuit board 34. Furthermore, in one embodiment, the third conductive portion 321 may be one end of the second conductive member 32 located outside the circuit board 34, and the fourth conductive portion 322 may be another end of the second conductive member 32 located outside the circuit board 34. The third conductive portion 321 and the fourth conductive portion 322 may be separated from and electrically connected to each other through the circuit board 34.

Referring to FIGS. 1 and 14, in one embodiment, the atomization device 100 defines an airflow channel 40. The airflow channel 40 extends through the cartridge module 10. The atomization device 100 further includes a sensor 50. The sensor 50 can sense an airflow in the airflow channel 40 to determine whether the user inhales to simulate movements of smoking. The sensor 50 is electrically connected to the first electrode 21 and the second electrode 22. The second end 31b of the first conductive member 31 is electrically connected to the first electrode 21 through the sensor 50.

As such, the airflow channel 40 of the atomization device 100, which extends through the cartridge module 10, can facilitate the flow of smoke along the airflow channel 40 that is formed by heating the e-liquid. The sensor 50, which is electrically connected to the first electrode 21 and the second electrode 22, can facilitate the atomization device 100 to sense the airflow in the airflow channel 40. Therefore, the sensor 50 can send a signal according to the sensed airflow to the battery module 20, thereby controlling the battery module 20 to energize the cartridge module 10.

In one embodiment, the airflow channel 40 may be located in the middle area of the cartridge module 10, and extend through the cartridge module 10 along the length direction of the atomization device 100. The sensor 50 can be an electronic device used to sense the airflow in the airflow channel 40. The sensor 50 may be located in the airflow channel 40, and electrically connected to the first electrode 21 and the second electrode 22 of the battery 24 through wires. When the user inhales the atomization device 100, the sensor 50 can sense the airflow in the airflow channel 40 and send the signal to the battery module 20.

Referring to FIGS. 5, 6, and 13, in one embodiment, the atomization device 100 further includes an insulation post 35. The insulation post 35 connects the second end 31b of the first conductive member 31 to the first electrode 21.

The insulation post 35 can firmly connect the first conductive member 31 to the first electrode 21, and also provide an insulation protection between the first conductive member 31 and the first electrode 21.

The second end 31b of the first conductive member 31 may be electrically connected to the first electrode 21 through the sensor 50. The insulation post 35 is provided on the second end 31b of the first conductive member 31 located in the second receiving space 335. The insulation post 35 may be a post of insulation rubber or plastic. The length of the insulation post 35 along the length direction of the atomization device 100 may be greater than 3 mm. The depth of the first conductive member 31 embedded in the insulation post 35 may be greater than 1.5 mm and less than or equal to 3 mm. A first elastic piece 351 protrudes from the insulation post 35. A second elastic piece 352 protrudes from the second end 31b of the first conductive member 31. A third elastic piece 353 protrudes from the second conductive member 32. The second elastic piece 352 and the third elastic piece 353 may be located in the second receiving space 335.

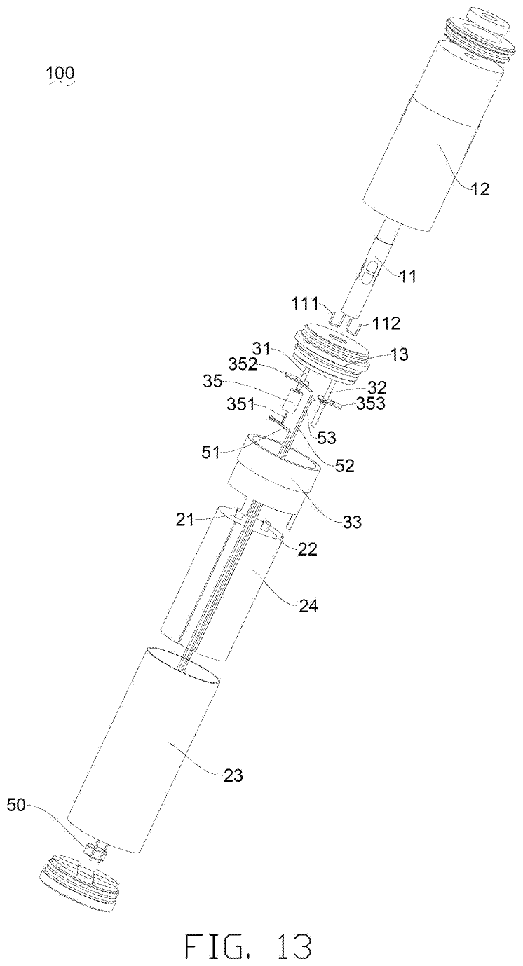

Referring to FIG. 13, the wires connecting the sensor 50 may include a first wire 51, a second wire 52, and a third wire 53. The first wire 51 and the second wire 52 can be connected in series through the sensor 50. The first wire 51 is further connected to the first electrode 21 of the battery 24 and the first elastic piece 351. The second wire 52 is further connected to the second elastic piece 352. The third wire 53 is further connected to the third elastic piece 353. The second end 31b of the first conductive member 31 is sealed by the insulation post 35, so that the first conductive member 31 cannot be directly connected to the first electrode 21. Instead, the first conductive member 31 is connected to the first wire 51 through the second wire 52 that is connected to the second elastic piece 352, thereby allowing the first conductive member 31 to connect to the first electrode 21 of the battery 24.

Referring to FIGS. 1 to 3 and 13, in one embodiment, the sensor 50 is located on an end of the battery module 20 away from the connection module 30. Referring to FIGS. 14, in another embodiment, the airflow channel 40 may further extend through the connection module 30. The sensor 50 may be located on the connection module 30.

By setting the sensor 50 on the battery module 20 or the connection module 30, the airflow in the airflow channel 40 can be sensed, so that the atomization device 100 can be operated based on the sensed airflow in the airflow channel 40.

In one embodiment, when the sensor 50 is located at the end of the battery module 20 away from the connection module 30, the sensor 50 may be located inside the housing 23 of the battery module 20 and adjacent to the end of the battery 24 away from the connection module 30. In another embodiment, when the sensor 50 is located on the connection module 30, the sensor 50 may be integrated on the connection module 30, for example, by an integration manner. At this time, the sensor 50 may be electrically connected to the second end 31b of the first conductive member 31 through a wire, and further electrically connected to the second end 32b of the second conductive member 32 through another wire. Thus, the sensor 50 can be connected to the first electrode 21 and the second electrode 22 of the battery module 20, and the working state of the battery 24 can be controlled based on the sensed airflow in the airflow channel 40.

References throughout the specification to “one embodiment”, “an embodiment”, “some embodiments”, or “example” mean that at least one embodiment or example of the present disclosure comprises specific features, structures, or characteristics described in the embodiments or examples. Thus, the descriptions appear throughout the specification, such as “in one embodiment”, “in an embodiment”, “in some embodiments”, “in an example”, or “for example” are not necessarily the same embodiment or example in the present disclosure.

Even though information and advantages of the present embodiments have been set forth in the foregoing description, together with details of the structures and functions of the present embodiments, the present disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An atomization device comprising:
a cartridge module comprising a heating member, the heating member comprising a first pin and a second pin;
a battery module comprising a first electrode and a second electrode; and
a connection module detachably connected to the cartridge module and the battery module, the connection module comprising a first conductive member and a second conductive member, wherein the first conductive member comprises a first end and a second end, the second conductive member comprises a first end and a second end, the first end of the first conductive member is in contact with the first pin, the second end of the first conductive member is electrically connected to the first electrode, the first end of the second conductive member is in contact with the second pin, and the second end of the second conductive member is in contact with the second electrode.

2. The atomization device according to claim 1, wherein the cartridge module further comprises a storage chamber and a sealing member configured to seal the storage chamber, and the first pin and the second pin are located on the sealing member.

3. The atomization device according to claim 2, wherein an end surface of the sealing member away from the storage chamber is recessed to form a first slot and a second slot, the first pin and the first end of the first conductive member are located in the first slot, and the second pin and the first end of the second conductive member are located in the second slot.

4. The atomization device according to claim 2, wherein the connection module further comprises a bracket detachably sleeved on the sealing member, and the first conductive member and the second conductive member are installed on the bracket.

5. The atomization device according to claim 4, wherein the bracket comprises a bracket body and a first wall connected to the bracket body, the bracket body and the first wall cooperatively define a first receiving space, the first conductive member and the second conductive member are inserted into the bracket body, and the sealing member is partially received in the first receiving space.

6. The atomization device according to claim 5, wherein the bracket body is provided with a first position limiting structure, the sealing member is provided with a second position limiting structure, and the first position limiting structure is connected to the second position limiting structure.

7. The atomization device according to claim 6, wherein the first position limiting structure comprises a first limiting block received in the first receiving space, the second position limiting structure comprises a first limiting groove defined on the sealing member, and the first limiting block is fixed in the first limiting groove.

8. The atomization device according to claim 5, wherein the bracket further comprises a second wall, the bracket body is located between the first wall and the second wall, and the second wall and the bracket body cooperatively define a second receiving space, each of the first conductive member and the second conductive member is partially received in the second receiving space, the battery module further comprises a battery and a housing, the battery is located in the housing, and the second wall is embedded in the housing.

9. The atomization device according to claim 1, wherein the battery module comprises a battery, the battery comprises a power end facing the cartridge module, and the first electrode and the second electrode are located on the power end.

10. The atomization device according to claim 8, wherein the battery further comprises a battery cell and a shell, the battery cell is located in the shell, the shell is provided with a third position limiting structure, the second wall is provided with a fourth position limiting structure, and the third position limiting structure is connected to the fourth position limiting structure.

11. The atomization device according to claim 10, wherein the third position limiting structure comprises a second limiting groove defined on the shell, the fourth position limiting structure comprises a second limiting block located at one end of the second wall away from the bracket body, and the second limiting block is fixed in the second limiting groove.

12. The atomization device according to claim 1, wherein the connection module further comprises a circuit board, the first conductive member and the second conductive member are installed on the circuit board, the first conductive member further comprises a first conductive portion and a second conductive portion separated from the first conductive portion, the first conductive portion comprises the first end of the first conductive member, the second conductive portion comprises the second end of the first conductive member, and the first conductive portion is electrically connected to the second conductive portion through the circuit board.

13. The atomization device according to claim 12, wherein the second conductive member further comprises a third conductive portion and a fourth conductive portion separated from the third conductive portion, the third conductive portion comprises the first end of the second conductive member, the fourth conductive portion comprises the second end of the second conductive member, and the third conductive portion is electrically connected to the fourth conductive portion through the circuit board.

14. The atomization device according to claim 1, wherein the atomization device defines an airflow channel, the airflow channel extends through the cartridge module, the atomization device further comprises a sensor, the sensor is configured to sense an airflow in the airflow channel, the sensor is electrically connected to the first electrode and the second electrode, and the second end of the first conductive member is electrically connected to the first electrode through the sensor.

15. The atomization device according to claim 14, further comprising an insulation post, wherein the insulation post connects the second end of the first conductive member to the first electrode.

16. The atomization device according to claim 15, further comprises a first elastic piece, a second elastic piece, a third elastic piece, and a plurality of wires, wherein the first elastic piece protrudes from the insulation post, the second elastic piece protrudes from the second end of the first conductive member, and the third elastic piece protrudes from the second conductive member, and
the plurality of wires comprises a first wire, a second wire, and a third wire each connected to the sensor, the first wire is further connected to the first electrode and the first elastic piece, the second wire is further connected to the second elastic piece, and the third wire is further connected to the third elastic piece.

17. The atomization device according to claim 14, wherein the sensor is located on one end of the battery module away from the connection module.

18. The atomization device according to claim 14, wherein the airflow channel further extends through the connection module, and the sensor is located on the connection module.

19. The atomization device according to claim 1, wherein the first electrode is annular surrounding an outer edge of the second electrode.

20. The atomization device according to claim 1, wherein the first electrode and the second electrode are conductive plates or conductive posts.
